(19) United States
(12) Patent Application Publication
(10) Pub. No.: US 2006/0150507 A1
(43) Pub. Date: Jul. 13, 2006

(54) Apparatus and method for planting geophytes

(76) Inventors: Richard McLean, Victoria (AU); Gary Whelan, Victoria (AU)

Correspondence Address: SEYFARTH SHAW LLP, 55 E. MONROE STREET, SUITE 4200, CHICAGO, IL, 60603-5803, US

(21) Appl. No.: 10/477,302

(22) PCT Filed: May 8, 2002
(86) PCT No.: PCT/AU02/00573

§ 371 Date: May 9, 2005

(30) Foreign Application Priority Data
May 28, 2001 (AU) PR 4824

(51) Int. Cl. A01G 9/02

(52) U.S. Cl. 47/86

(57) ABSTRACT

A planter for planting geophytes including a plurality of spaced apart holders, each of the holders being configured to receive a geophyte, whereby in use the geophytes may be placed in the holders and planted by burying the planter under soil.

### FIELD OF THE INVENTION

The present invention relates to an apparatus and method for planting geophytes.

### BACKGROUND OF THE INVENTION

A geophyte is a herbaceous plant with an underground storage organ. Essentially, the storage organ allows the plant to survive harsh climatic conditions by storing reserves of carbohydrates, nutrients and water. During harsh climatic conditions (e.g., temperature extremes) the above ground portion of a geophyte dies, leaving only the storage organ in the soil. This phase of a geophyte's life is commonly referred to as the dormant period or resting stage. A dormant geophyte constantly monitors its environment, and will sprout an above ground portion when the climatic conditions are suitable. As a result of this characteristic, geophytes often have a perennial life cycle.

The best known type of geophyte would have to be the bulbous variety including, for example, tulips, irises, lilies and daffodils. Their vibrant colours make them a popular choice in custom garden beds where they are commonly used to plant out, for example, a corporate name, logo or municipal clock. Other types of geophyte plants are corms, tubers, rhizomes and enlarged hypocotyls.

As with other plants, geophytes are planted by placing them into a trench or hole (of the appropriate depth) in soil. Subsequent to which the trench or hole is backfilled. Whilst some geophytes can be left in the ground to re-flower year after year, many geophytes must be removed from the soil annually when in their dormant period. This allows the storage organ to dry off. It is only during the final stages of drying off that embryo flowers can form in the storage organ. If drying off does not take place then it is unlikely that embryo flowers will form. Furthermore, if the storage organ is not allowed to dry off it will become weakened and eventually rot away below the soil.

Traditionally, geophytes are removed from the soil by manually locating and digging up each of the geophytes. This is a time consuming a tedious process, particularly when geophytes are used in custom garden beds where they are commonly planted by the hundreds of thousands.

### SUMMARY OF THE INVENTION

It is therefore an object of the present invention to provide an alternative apparatus and method for planting geophytes.

According to a first aspect of the present invention, there is provided a planter for planting geophytes, including;

a plurality of spaced apart holders, each of which is made from an open weave material; and

a locator which is arranged to be connected to a body portion of the planter in which the holders are formed,

whereby in use the geophytes may be placed in the holders and planted by burying the planter under soil, the open weave material allowing the geophytes in the holders to come into contact with the soil to thereby stimulate growth of the geophytes, the locator allowing a user to locate the planter when the planter is buried under soil.

Preferably, the holders are configured to hold the geophytes in an orientation selected by the user.

Preferably, the body portion is formed from overlying lengths of material which are attached at intervals along the length of the overlying material to form the holders.

Preferably, the locator is a member having a length which allows a portion of the member to protrude above the soil when the planter is buried under the soil.

Preferably, the member has a marking for indicating the depth at which the planter is to be buried under the soil.

Preferably, the locator is detachable from the holders.

According to a second aspect, the present invention provides a method for planting geophytes, including the steps of:

placing the geophytes into a plurality of holders, the holders forming part of a planter;

burying the planter under soil to thereby plant the geophytes; and

retrieving the planter when buried under soil by pulling on a locator which protrudes from the soil, the locator being a member which is connected to a body portion of the planter.

### A BRIEF DESCRIPTION OF THE DRAWINGS

A preferred embodiment of the present invention will now be described in detail, by way of example, with reference to the accompanying drawings, in which:

FIG. 1 shows the planter;

FIG. 2 shows the planter placed in a trench in soil; and

FIG. 3 is a view of the planter when buried under soil.

### A DETAILED DESCRIPTION OF THE PREFERRED EMBODIMENT

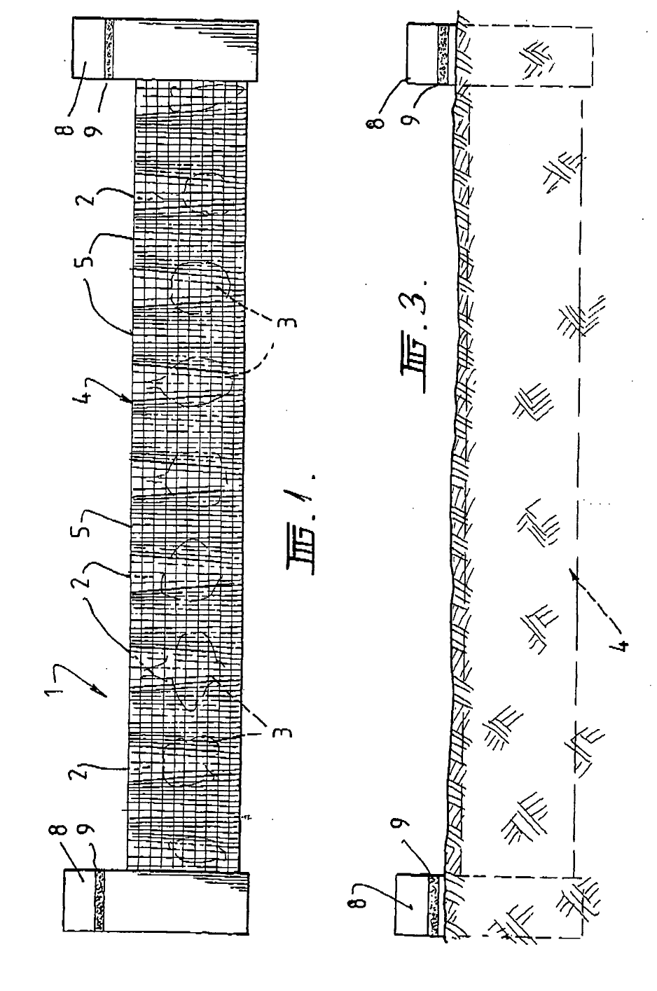

With reference to FIG. 1, the planter 1 includes a plurality of spaced apart holders 2 for holding the geophytes 3. The holders 2 form part of a body portion 4. The holders 2 and body portion 4 can be integrally formed from overlying lengths of material which are attached 5 at intervals along their length. The overlying material has openings 6 located between the attached 5 points, thus forming the holders 2 into which the geophytes 3 can be placed.

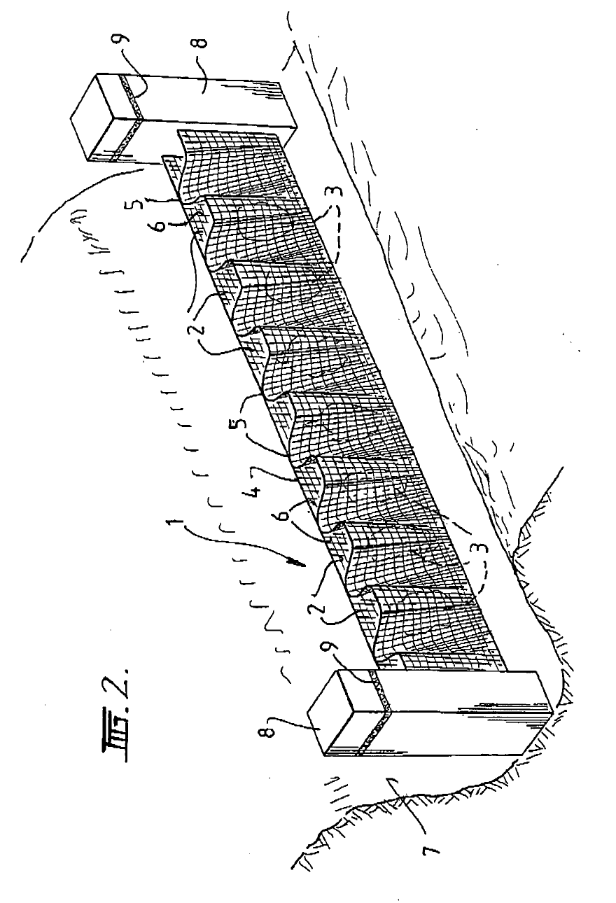

As shown in FIG. 2, once the geophytes 3 have been placed into the holders 2, the geophytes 3 can be planted by placing the planter 1 into a trench 7, of the appropriate depth, in the soil and subsequently backfilling the trench 7.

To stimulate growth of the geophytes 3 when the planter 1 is buried, the holders 2 can be made from, for example, an open weave material. This allows the geophytes 3 to be in contact with the soil so that they can acquire the necessary nutrients. The holders 2 can also be configured to hold the geophytes 3 in a position determined by the user. This position can, for example, be one that assists the growth of the geophyte 3.

To prevent the planter 1 from degrading when buried under soil, the body portion 4 and the holders 2 can be made from, for example, polyvinyl chloride (PVC) or fibre glass. Using a material such as PVC provides several advantages. For instance, it allows the body portion 4 and holders 2 to be easily manufactured by using overlying lengths of the material and heat welding them at intervals along their length.

The body portion 4 may also be made from a flexible material. This allows a user to arrange the planter 1 as required. For example, a user could easily arrange the planter 1 to resemble the letter “s”.

As can been seen in FIGS. 1 and 2, the planter 1 also includes a locator 8 for allowing a user to easily locate the planter 1 when buried under soil. The locator 8 includes two members which can be, for example, rods made from a plastic material. Each of the two members can be connected to a different end of the body portion 4.

As is shown in FIG. 3, the members are of a sufficient length to have a portion that protrudes from the soil when the planter 1 is buried under soil. The protruding portion of the member allows a user to visually locate the planter 1 with ease. The protruding portion also allows the user to quickly retrieve the geophytes 3. Once located, a user simply grabs the protruding portion of the member and pulls in a direction away from the soil; thereby retrieving the planter 1 along with the geophytes 3. When retrieved, the planter 1 and geophytes 3 can be easily cleaned and treated with fungicide if required. For example, the planter 1 may be hung on a washing line or similar, hosed down to clean the planter 1 and geophytes 3 of dirt and then sprayed with fungicide. The planter 1 can also be stored away to allow the geophytes 3 to dry off in preparation for the next season.

As can be seen in FIGS. 1-3, the locator 8 has a marking 9 which serves as an indicator of the depth at which the planter 1 should be buried. The marking 9 also serves as an indication to the user of the correct depth at which the geophytes 3 should be buried. As is illustrated in FIG. 3, the planter 1 is buried so that the marking 9 is at the surface of the soil. There may be a number of markings 9 on the locator 8, each marking 9 corresponding to a different depth at which the geophytes will be buried thus enabling a user to bury geophytes 3 at the depth which best stimulates their growth.

The locator 8 may be integrally formed with the body portion 4, or may be configured to be selectively attached/detached to/from the body portion 4 as required by the user. In the later embodiment, the depth at which the planter 8 is to be buried can be selective adjusted by attaching the locator 8 at the appropriate position on the body portion 4.

As mentioned previously, FIGS. 1-3 show two locators 8, each of which is connected to a different end of the body portion 4. In an alternative embodiment, the planter 1 may have numerous locators 8 connected to the body portion 4. Each of the locators 8 being spaced apart at intervals along the body portion 4. In another embodiment only a single locator 8 may be employed, and this locator 8 may be connected anywhere along the length of the body portion 4. In a less preferred embodiment, the planter 1 does not incorporate a locator 8 it will be appreciated that in this embodiment a user will need to either use a separate locating means to indicate the location of the planter 1, or will need to dig around the soil until they locate the planter 1.

Whilst the holders 2 are illustrated in FIGS. 2 and 3 as being of the same size and spaced apart at regular intervals, the holders 2 can be of different sizes and spaced apart at irregular intervals to accommodate geophytes 1 of different shapes and sizes.

The planter 1 may also come in range of colours and different lengths. The range of colours can be used as a means for readily identifying the type of geophytes 3 in the holders 2. For example, a user may opt to use a red planter 1 in relation to tulips, and a blue planter 1 in relation to daffodils. The colours could also be used as a means for identifying the season in which the geophytes 3 can be buried. For example, a red planter 1 may be used to hold geophytes 3 which are to be planted in summer.

The length of the planter 1 can be selected based on the needs of the user. For instance, if the user required a row of geophytes one meter long then a planter 1 of approximately one meter can be selected.

It will be appreciated that the planter 1 may be supplied in kit form including a roll of material and a plurality of locators 8, whereby a user may form planters 1 by cutting lengths of material and attaching one or more locators 8 to the lengths of material.

It should also be noted that a user may employ a number of planters 1 in order to achieve the desired result; for example, to form a pattern such as a corporate logo.

It will be understood to persons skilled in the art of the invention that many modifications may be made without departing from the spirit and scope of the invention.

1-9. (canceled)

13. A planter for planting geophytes, comprising:
a plurality of spaced apart holders, each of the holders being configured to receive a geophyte,
whereby in use geophytes may be placed in the holders and planted by burying the planter under soil.

14. The planter as claimed in claim 13, wherein the holders are made from an open weave material for allowing the geophytes in the holders to come into contact with the soil when the planter is buried under the soil, thereby stimulating growth of the geophytes.

15. The planter as claimed in claim 13, wherein the holders are configured to hold the geophytes in an orientation selected by the user.

16. The planter as claimed in claim 13, further comprising a locator for allowing a user to locate the planter when buried under the soil, the locator being connected to a body portion of the planter in which the holders are formed.

17. The planter as claimed in claim 16, wherein the body portion is formed from overlaying lengths of material which are attached at intervals along the length of the overlying material to form the holders.

18. The planter as claimed in claim 16, wherein the locator is a member having a length which allows a portion of the member to protrude above the soil when the planter is buried under the soil.

19. The planter as claimed in claim 18, wherein the member has a marking for indicating the depth at which the planter is to be buried under the soil.

20. The planter as claimed in claim 16, wherein the locator is detachable from the holders.

21. A method for planting geophytes, comprising the steps of:
placing the geophytes into a plurality of holders, the holders forming part of a planter; and
burying the planter under soil to thereby plant the geophytes.

22. The method as claimed in claim 21, further comprising the step of retrieving the planter when buried under soil by pulling on a locator which protrudes from the soil, the locator being a member which is connected to a body portion of the planter.

23. A planter for planting geophytes, substantially as herein described with reference to the accompanying figures.

24. A method for planting geophytes, substantially as herein described with reference to the accompanying figures.
